(19) United States
(12) Patent Application Publication
(10) Pub. No.: US 2018/0300768 A1
(43) Pub. Date: Oct. 18, 2018

(54) AUTOMATIC BID GENERATION

(71) Applicant: Google LLC, Mountain View, CA (US)

(72) Inventors: Adam Samet, New York, NY (US); Wilfred M. Yeung, Somerset, NJ (US); Diogo V. Andrade, Highland Park, NJ (US); Daniel Eaton, New York, NY (US); Yuriy Znovyak, New York, NY (US); William E. Walsh, New York, NY (US); Babu Rao Kashyap Kolipaka, Iselin, NJ (US)

(21) Appl. No.: 15/976,445

(22) Filed: May 10, 2018

Related U.S. Application Data
(63) Continuation of application No. 13/990,651, filed on May 30, 2013.

(51) Int. Cl. G06Q 30/02; G06Q 30/08

(52) U.S. Cl. CPC G06Q 30/0275; G06Q 30/08; G06Q 30/0244

(57) ABSTRACT

Example techniques may include: receiving information from a content provider; generating a bidding strategy based on the information, where the bidding strategy indicates a percentage of first content to be presented at a specified location on a computing device display; generating an initial bid for the one or more criteria associated with the first content in a content auction based on performance of second content that has one or more attributes in common with the first content, where the initial bid includes a monetary amount to pay in the content auction for an action relating to the first content; determining performance metrics for the one or more criteria and the initial bid based on results of the content auction; and automatically determining a revised bid for the one or more criteria based on the performance metrics and the bidding strategy.

### CROSS-REFERENCE TO RELATED APPLICATIONS

This application is a continuation application of, and claims priority to, U.S. patent application Ser. No. 13/990,651, titled “AUTOMATIC BID GENERATION,” filed on May 30, 2013, which application claims the benefit of priority under PCT/UA2013/000013, titled “AUTOMATIC BID GENERATION,” filed on Jan. 29, 2013. The disclosure of the foregoing applications are incorporated herein by reference in their entirety for all purposes.

### TECHNICAL FIELD

This disclosure relates generally to generating bids for a content auction automatically.

### BACKGROUND

The Internet provides access to a wide variety of resources. For example, video, audio, and Web pages are accessible over the Internet. These resources present opportunities for other content (e.g., advertisements, or “ads”) to be provided along with the resources. For example, a Web page can include slots in which ads can be presented. The slots can be allocated to content providers (e.g., advertisers). An auction can be performed for the right to present advertising in a slot. In some auctions, content providers provide bids specifying amounts that the content providers are willing to pay for their content to be clicked-on.

The success of content, such as an ad, may be measured in terms of network activity, such as a click-through rate (CTR). In this context, a click-through includes selection of a content item that causes the user to be “clicked through” to a Web page or other resource linked to the content. Some locations on a Web page, such as a search results page, are more likely to result in click-throughs, and thus a higher CTR, than other locations on that page or other, related pages. These locations tend to be areas where users look first. For example, content presented on the top of a first page of search results may be more likely to be viewed than content that is presented on the bottom of a second page of results for the same search.

### SUMMARY

Example techniques for performing automatic bid generation may include: receiving information from a content provider; and generating a bidding strategy based on the information, where the bidding strategy indicates a percentage of first content to be presented at a specified location on a computing device display, the percentage of first content is a ratio of a total number of impressions of the first content to a number of impressions of the first content that could be presented at the specified location, and the first content is associated with one or more criteria for providing content of interest. The example techniques may also include the following: generating an initial bid for the one or more criteria in a content auction based on performance of second content that has one or more attributes in common with the first content, where the initial bid includes a monetary amount to pay in the content auction for an action relating to the first content; determining performance metrics for the one or more criteria and the initial bid based on results of the content auction; and automatically determining a revised bid for the one or more criteria based on the performance metrics and the bidding strategy. The example techniques may include one or more of the following features, either alone or in combination.

The one or more attributes may include one or more of the following relating to the first and second content: creative, text, keywords, geographic information, and temporal information. The second content may include multiple content items and generating the initial bid may include considering an aggregate of past performance of the multiple content items in auctions.

The performance metrics may include a percentage of first content presented at the specified location. The performance metrics may be first performance metrics, and determining a revised bid may include: changing the initial bid to produce a changed bid; determining additional performance metrics for the one or more criteria and the changed bid based on results of the content auction; generating a function relating bid amount to number of impressions at the specified location; and determining the revised bid using the function.

The function may include a graph relating bid amount and the number of impressions at the specified location. Determining the revised bid may include selecting the revised bid from the graph. The function may include a graph relating bid amount and the number of impressions at the specified location. Determining the revised bid may include selecting the revised bid from the graph and processing the revised bid with one or more prior bids for the criteria. The one or more prior bids may be at different times than the initial bid.

The example techniques may also include associating the bidding strategy with one or more entities of an account maintained by the content provider, the one or more entities comprising the first content. The revised bid may comply with the bidding strategy better than the initial bid.

The one or more criteria may include one or more keywords. The one or more criteria may include criteria other than keywords. The specified location may include a location on a page or one page of multiple pages.

Two or more of the features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features, objects, and advantages will be apparent from the description and drawings, and from the claims.

### DESCRIPTION OF DRAWINGS

FIG. 1 is a block diagram showing an example search results page.

FIG. 2 is a block diagram showing, conceptually, an example process for automatically generating bids for an online content auction.

FIG. 3 is an example graph showing impression share plotted against bid price.

FIG. 4 is a block diagram of an example network environment on which the example processes described herein can be implemented.

FIG. 5 is a flowchart showing an example process for automatically generating bids for an online content auction.

Like reference symbols in the various drawings indicate like elements.

### DETAILED DESCRIPTION

Content, such as advertising, may be provided to network users based, e.g., on demographics, keywords, geography or other criteria. For example, advertising (an “ad”) may be associated with one or more keywords that are stored as metadata along with the ad. A search engine, which operates on the network, may receive input from a user. The input may include one or more of the keywords. A content management system, which serves ads, may receive the keywords from the search engine, identify the ad as being associated with one or more of the keywords, and output the ad to the user, along with content that satisfies the initial search request. The content and the ad are displayed on a computing device. When displayed, the ad is incorporated into an appropriate slot on the results page. The user may select the ad by clicking-on the ad. In response, a hyperlink associated with the ad directs the user to another Web page. For example, if the ad is for ABC Travel Company, the Web page to which the user is directed may be the home page for ABC Travel Company. This activity is known as click-through. In this context, a “click” is not limited to a mouse click, but rather may include a touch, a programmatic selection, or any other interaction by which the ad may be selected.

A content auction is typically run to determine which content is to be output in response to an input, such as one or more keywords. In some auctions, content providers may bid on specific keywords (which are associated with their content). In other auctions, content providers may bid on other criteria (e.g., geography) that may be used to provide content of interest to users. Although the examples described herein use keywords as the criteria, any other appropriate criteria may be used in place of keywords. Taking keywords as an example, a sporting goods ads provider may associate words such as “baseball”, “football” and “basketball” with their ads. The content provider may bid on those keywords in the content auction, typically on a cost-per-click (CPC) basis. In some cases, the CPC bid is a maximum amount that the provider will pay (the cost) in response to users clicking on their displayed content. So, for example, if a content provider bids five cents per click, then the content provider pays, at most, five cents each time their content is clicked-on by a user. In other examples, payment need not be on a CPC basis, but rather may be on the basis of other actions (e.g., an amount of time spent on a landing page, a purchase, and so forth).

Bidding in a content auction typically takes place against other content providers bidding for the same keywords. So, for example, if a user enters keywords into a search engine (to perform a search for related content), a content management system may select content items from different content providers, which are associated with those same keywords or variants thereof. The content auction is then run (e.g., by the content management system) to determine which content to serve along with the search results (or any other requested content). Typically, if two content items are of equal quality, the highest bidder wins the most preferred slots on a results page. If two items are not of equal quality, then a combination of quality and bid amount may be used to determine the winner. In this context, a page includes any display area, such as a Web page, a continuously scrollable screen, and so forth. In some examples, winners of the auction will be accorded the most preferred slot(s) on the page, while others will be accorded slots that are less preferred. In this regard, a slot on a page may include any appropriate area of the page, or any item output with the page (such as a pop-up), that is reserved for display of non-requested content, such as advertising.

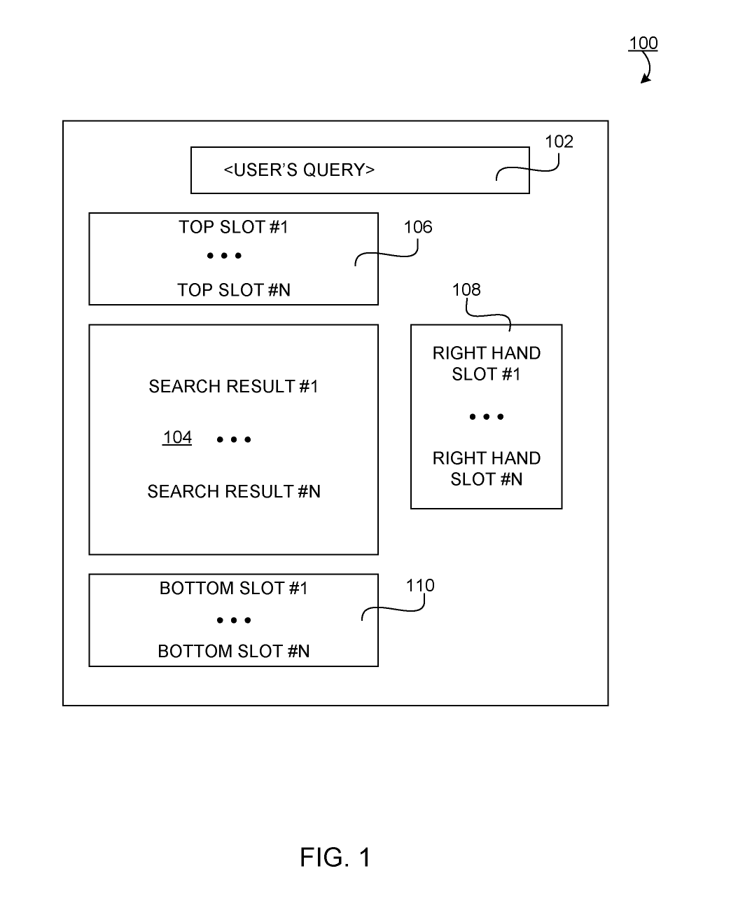

Some areas of a page (e.g., slots) or group of pages are preferred over others based on their location. For example, the first page of a group of pages is typically the preferred page. Likewise, the top of a page is typically preferred to other areas of the pages, since that is where uses typically look first. In this regard, FIG. 1 shows an example search result page 100 containing a field 102 for displaying a user query (e.g., keywords, images, audio, video, and so forth), and an area 104 for displaying search results responsive to the user query in field 102. Page 100 also includes various content slots, including top slots 106, right hand slots 108, and bottom slots 110. Page 100 is simply an example of slots on a page. Other pages may contain different numbers or combinations of slots, including left hand slots, pop-up slots, and so forth. In any case, some slots are preferred over others, primarily because content posted to those slots are more likely to be interacted with than content in less preferred slots. Typically, preferred slots are in more prominent areas of a display, such as the top of the display; however, this need not always be the case. As noted, in some cases, a preferred display area is not a slot, but rather a page. For example, a content provider may wish to present content anywhere on a first page of search results that include multiple pages. The following example implementations assume use of a preferred slot and/or page.

As noted, content providers typically want to display their content in the preferred slots (and/or page(s)) since content presented there is more likely to be interacted with (e.g., clicked-on) than content in less preferred areas. Bids, however, are not always successful at winning a content auction for the preferred slots. In some cases, a low bid at auction results in no displayed content. In other cases, a low bid at auction results in display of content in non-preferred areas (e.g., a second pages of search results, a bottom of a page, etc.). The automated bid selection process described herein can, in some cases, manage a provider's bids so as to make it more likely that the provider's content will present in preferred areas. In some example implementations, the automated bid selection process includes a content provider specifying a preferred goal or methodology for setting bids (referred to as a bid strategy), and then the system determines bids going forward with little or no subsequent intervention from the content provider. Although the automated bid selection process is applicable to generate bids for any appropriate content, the examples provided below are for online advertising.

In the case of online advertising, advertisers typically want to present their impressions (presentations of ads) towards the first page of search results, or in the top slot of the first page (the most prominent place to show in search results—typically located in a colored box between the search bar and the first organic/non-paid search result). This goal may be motivated by branding reasons, e.g., to attract the most “eyeballs” (e.g. users who actually see the ad) and/or to drive more click-throughs to the advertiser's Web site. One way to express this goal is by selecting a specific impression share for a particular page/slot location of search results. For example, the goal may be to bid automatically to achieve X % of total potential impressions to be shown on the first page of search results, or to bid to get Y % of total eligible first page top slot impressions to be shown in the top slot of the first page of search results. “Potential total impressions”, in some examples, not only includes impressions that were actually shown, but impressions that were not shown (content auction losers), but had the potential to show, if only the bid had been higher. Thus, in this example, the goal specifically considers unshown impressions as well, which may have been lost, for example, to an advertiser's competitor(s).

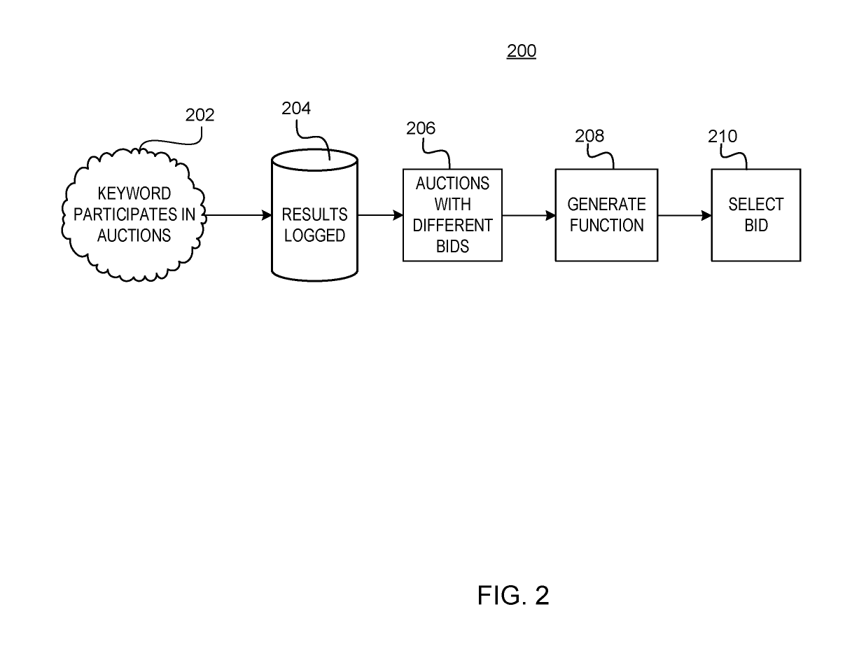

FIG. 2 shows, conceptually, an example automated bid selection process 200 for generating bids in accordance with a predefined bidding strategy. In the example of FIG. 2, the bidding strategy is set beforehand, and an initial bid is set. The initial bid is used in an online auction (202) to bid on keywords corresponding to content to be shown at specified locations. Results of the online auction with the initial bid are logged (204), e.g., stored in a database. The results obtained over numerous auctions may indicate, for example, the percentage of impressions that achieved the result set in the bidding strategy. For example, the results may indicate the percentage of impressions that were shown at the top slot on a first search results page as a result of the initial bid. Results logged may include, e.g., all content that participated (shown or not) in an auction, information about bids for the content, effected price, content quality, and so forth.

Thereafter, additional auctions (206) are run. These additional auctions may be real auctions or simulated auctions (e.g., simulations following the rules and processes of actual auctions). In successive auctions, the bid is changed (either increased or decreased) to obtain different auction performance metrics. In some examples, the system changes the bid automatically, e.g., without intervention or input from the content provider whose bid it is. In some examples, the bid amount is changed so that auction results converge on the desired percentage of impressions that are to be shown at a desired slot and/or page as a result of the corresponding bid. In other examples, this need not be the case. Information obtained from the various auctions may be used to generate a function (208) relating bid price (e.g., CPC bid amount) to an impression share at a particular slot and/or page. The function may be mathematical and/or graphical. The function may be used to select (210) a bid to achieve the goal set forth in the bidding strategy.

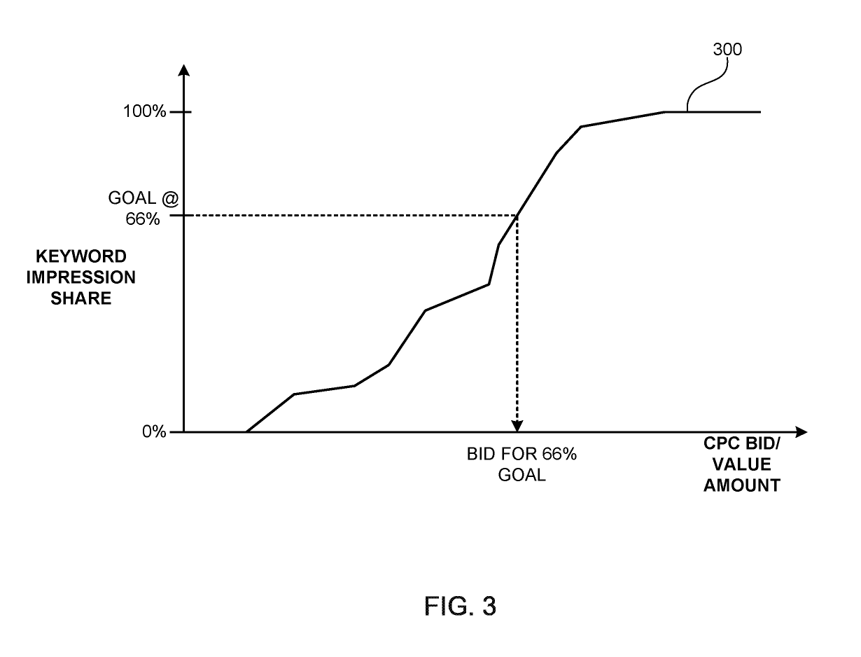

By way of example, FIG. 3 shows a graphical function 300 that relates CPC bid amount to keyword impression share displayed at a location on search results. In the example of FIG. 3, the goal set in the bidding strategy is that 66% of content from a content provider be displayed, through an online auction, at the top of a first page of search results (or at the top of the page if there is only one page). As shown in the figure, by selecting that goal percentage on the Y axis of the graph, the corresponding bid used to achieve that goal can also be identified.

The bidding strategy, and subsequent automatic bid generation, can be applied to an entire campaign, e.g., an ad campaign for an advertiser. Such an ad campaign may contain multiple groups of ads for different products, locations, geographies, and the like to which an advertiser will send ads. Alternatively, the bidding strategy, and subsequent automatic bid generation, can be applied to a subset of a campaign. For example, the bidding strategy, and subsequent automatic bid generation, can be applied to one or more ads or groups of ads that are part of a campaign. Alternatively, the bidding strategy, and subsequent automatic bid generation, may be applied only to ads for locations, geographies, and the like.

In the example processes described herein, keywords are used as the criteria for providing content of interest to users, and are also associated with content items to be served. However, other types of information may be used for the criteria. For example, query input may include, alone or in combination, images, audio, video, or the like, which may match corresponding information associated with corresponding content. In another example, content may be associated with other criteria, such as geography, which may be used to provide content of interest to users. In such examples, geography may be associated with content and matched to information from a corresponding query. In such cases, the online auction may be based on these types of information.

The example process described herein can be implemented in any appropriate network environment, with any appropriate devices and computing equipment. An example of such an environment is described below.

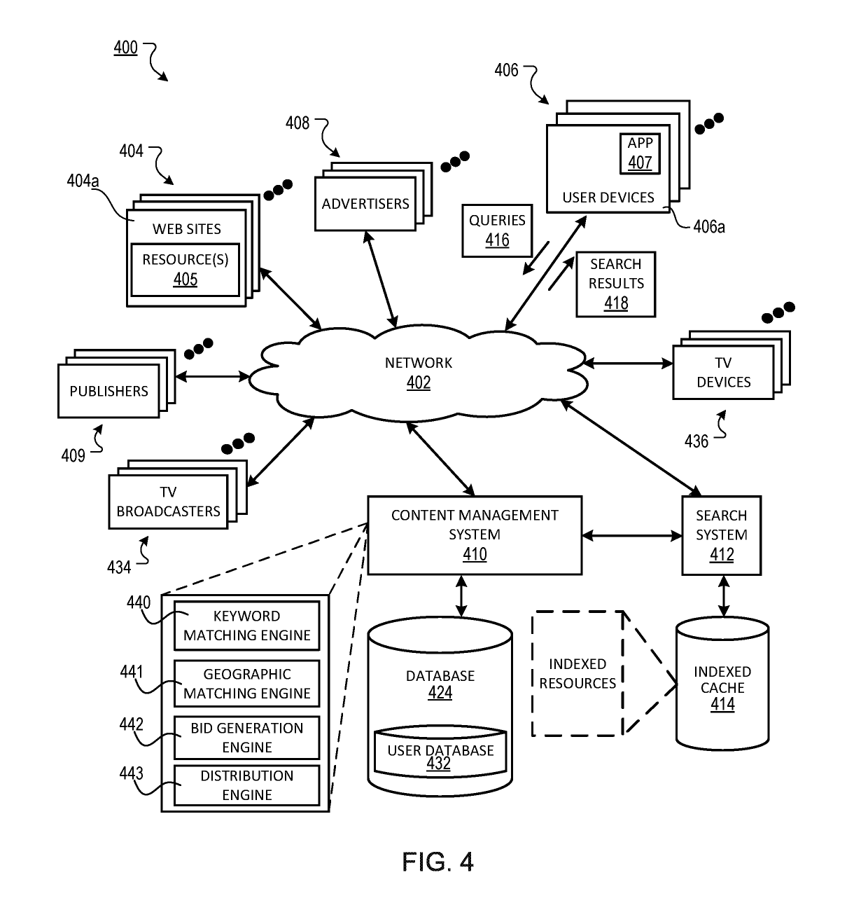

FIG. 4 is a block diagram of an example environment 400 for providing content to a user of a user device in accordance with the example processes described herein. The example environment 400 includes a network 402.

Network 402 can represent a communications network that can allow devices, such as a user device 406a, to communicate with entities on the network through a communication interface (not shown), which can include digital signal processing circuitry. Network 402 can include one or more networks. The network(s) can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication can occur through a radio-frequency transceiver. In addition, short-range communication can occur, such as using a Bluetooth, WiFi, or other such transceiver.

Network 402 connects various entities, such as Web sites 404, user devices 406, content providers (e.g., advertisers 408), online publishers 409, and a content management system 410. In this regard, example environment 400 can include many thousands of Web sites 404, user devices 406, and content providers (e.g., advertisers 408). Entities connected to network 402 include and/or connect through one or more servers. Each such server can be one or more of various forms of servers, such as a Web server, an application server, a proxy server, a network server, or a server farm. Each server can include one or more processing devices, memory, and a storage system.

In FIG. 4, Web sites 404 can include one or more resources 405 associated with a domain name and hosted by one or more servers. An example Web site 404a is a collection of Web pages formatted in hypertext markup language (HTML) that can contain text, images, multimedia content, and programming elements, such as scripts. Each Web site 404 can be maintained by a publisher 409, which is an entity that controls, manages and/or owns the Web site 404.

A resource 405 can be any appropriate data that can be provided over network 402. A resource 405 can be identified by a resource address that is associated with the resource 405. Resources 405 can include HTML pages, word processing documents, portable document format (PDF) documents, images, video, and news feed sources, to name a few. Resources 405 can include content, such as words, phrases, images and sounds, that can include embedded information (such as meta-information hyperlinks) and/or embedded instructions (such as JavaScript scripts).

To facilitate searching of resources 405, environment 400 can include a search system 412 that identifies the resources 405 by crawling and indexing the resources 405 provided by the content publishers on the Web sites 404. Data about the resources 405 can be indexed based on the resource 405 to which the data corresponds. The indexed and, optionally, cached copies of the resources 405 can be stored in an indexed cache 414.

An example user device 406a is an electronic device that is under control of a user and that is capable of requesting and receiving resources over the network 402. A user device can include one or more processing devices, and can be, or include, a mobile telephone (e.g., a smartphone), a laptop computer, a handheld computer, an interactive or so-called “smart” television or set-top box, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle (e.g., an automobile, an emergency vehicle (e.g., fire truck, ambulance), a bus).

User device 406a typically stores one or more user applications, such as a Web browser, to facilitate the sending and receiving of data over the network 402. A user device 406a that is mobile (or simply, “mobile device”), such as a smartphone or a table computer, can include an application (“app”) 407 that allows the user to conduct a network (e.g., Web) search. User devices 406 can also be equipped with software to communicate with a GPS system, thereby enabling the GPS system to locate the mobile device.

User device 406a can request resources 405 from a Web site 404a. In turn, data representing the resource 405 can be provided to the user device 406a for presentation by the user device 406a. User devices 406 can also submit search queries 416 to the search system 412 over the network 402. A request for a resource 405 or a search query 416 sent from a user device 406 can include an identifier, such as a cookie, identifying the user of the user device.

In response to a search query 416, the search system 412 can access the indexed cache 414 to identify resources 405 that are relevant to the search query 416. The search system 412 identifies the resources 405 in the form of search results 418 and returns the search results 418 to a user device 406 in search results pages. A search result 418 can include data generated by the search system 412 that identifies a resource 405 that is responsive to a particular search query 416, and includes a link to the resource 405. An example search result 418 can include a Web page title, a snippet of text or a portion of an image obtained from the Web page, and the URL (Unified Resource Location) of the Web page.

Content management system 410 can be used for selecting and providing content in response to requests for content. Content management system 410 also can, with appropriate user permission, update database 424 based on activity of a user. The user may enable and/or disable the storing of such information. In this regard, with appropriate user permission, the database 424 can store a profile for the user which includes, for example, information about past user activities, such as visits to a place or event, past requests for resources 405, past search queries 416, other requests for content, Web sites visited, or interactions with content. User interests may also be stored in the profile and, in some examples, may be determined from the information about past user activities. In some implementations, the information in database 424 can be derived, for example, from one or more of a query log, an advertisement log, or requests for content. The database 424 can include, for each entry, a cookie identifying the user, a timestamp, an IP (Internet Protocol) address associated with a requesting user device 406, a type of usage, and details associated with the usage.

Content management system 410 may include a keyword matching engine 440 to compare query keywords to content keywords and to generate a keyword matching score indicative of how well the query keywords match the content keywords. In an example, the keyword matching score is equal, or proportional, to a sum of a number of matches of words in the input query to words associated with the content. Content management system 410 may include a geographic (or “geo-”) matching engine 441 to compare geographic information (e.g., numerical values for place names) obtained from words in input queries to geographic information associated with content.

When a resource 405 or search results 418 are requested by a user device 406, content management system 410 can receive a request for content to be provided with the resource 405 or search results 418. The request for content can include characteristics of one or more “slots” that are defined for the requested resource 405 or search results page. For example, the data representing the resource 405 can include data specifying a portion of the resource 405 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 410. For example, a reference (e.g., URL) to the resource for which the slot is defined, a size of the slot, and/or media types that are available for presentation in the slot can be provided to the content management system 410. Similarly, keywords associated with a requested resource or a search query 416 for which search results are requested can also be provided to the content management system 410 to facilitate identification of content that is relevant to the resource or search query 416.

Based at least in part on data generated from and/or included in the request, content management system 410 can select content that is eligible to be provided in response to the request (“eligible content items”). For example, eligible content items can include eligible ads having characteristics matching keywords and/or geographic information associated with corresponding content. In some implementations, the universe of eligible content items (e.g., ads) can be narrowed by taking into account other factors, such as previous search queries 416. For example, content items corresponding to historical search activities of the user including, e.g., search keywords used, particular content interacted with, sites visited by the user, etc. can also be used in the selection of eligible content items by the content management system 410.

Content management system 410 can select the eligible content items that are to be provided for presentation in slots of a resource 405 or search results page 418 based, at least in part, on results of an auction, such as a second price auction. For example, for eligible content items, content management system 410 can receive bids from content providers (e.g., advertisers 408) and allocate slots, based at least in part on the received bids (e.g., based on the highest bidders at the conclusion of the auction). In some examples, the bids are amounts that the content providers are willing to pay for selection (e.g., clicking) of their content with a resource 405 or search results page 418. For example, a bid for keywords can specify an amount that a content provider is willing to pay for each 1000 clicks of the content item, referred to as a CPM bid. Alternatively, the bid for keywords can specify an amount that the content provider is willing to pay for a conversion following selection of the content item. This is referred to as cost-per-action (CPA). The selected content item can be determined based on the bids alone, or based on the bids of each bidder being multiplied by one or more factors, such as quality scores derived from content performance, landing page scores, and/or other factors.

In some implementations, a content provider can bid for an audience of users. For example, one or more of the publishers 409 and/or the content management system 410 can identify one or more audiences of users, where each user in the audience matches one or more criteria, such as matching one or more demographics. An audience of users can be represented, for example, as a user list. User lists or other representations of audiences can be stored, for example, in a user database 432. A bid from a content provider can specify, for example, an amount that the content provider is willing to pay for each 1000 impressions (i.e., presentations) of the content item to a particular audience of users. The content management system 410 can, for example, manage the presentation of the content item to users included in a particular audience and can manage charging of the content provider for the impressions and distributing revenue to the publishers 409 based on the impressions.

In some implementations, TV (Television) broadcasters 434 produce and present television content on TV user devices 436, where the television content can be organized into one or more channels. The TV broadcasters 434 can include, along with the television content, one or more content slots in which other content (e.g., advertisements) can be presented. For example, a TV network can sell slots of advertising to advertisers in television programs that they broadcast. Some or all of the content slots can be described in terms of user audiences which represent typical users who watch content with which a respective content slot is associated. Content providers can bid, in an auction (as described above), on a content slot that is associated with keywords for particular television content.

Content management system 410 may include a bid generation engine 442. Bid generation engine 442 may implement all or part of the example automated bid selection processes described herein. Content selected for output through such an online content auction may be distributed by content distribution engine 443, which is also part of the content management system.

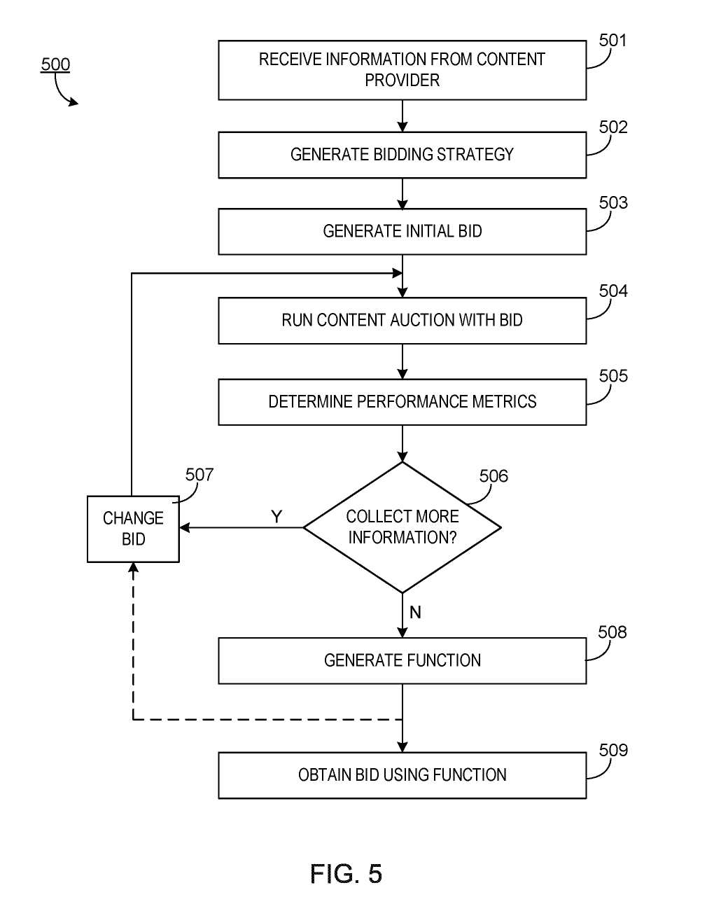

FIG. 5 is a flowchart showing an example process 500 that may be performed by content management system 410 including, at least partly, by bid generation engine 442 for generating bids automatically. Process 500 is described in the context of online advertising; however, it is applicable to generating bids for an auction for any online content. Also, process 500 is described in the context of a campaign; however, as noted above, process 500 may also be applied to any subset of a campaign or to multiple campaigns from a content provider.

According to process 500, information is received (501) from a content provider. For example, content management system 410 may provide an online portal, through which an advertiser may enter information about an ad campaign. The information may include, among other things, an ad creative, keywords associated with the ad, geographic information, and other information that is usable to distribute the ad along with other content such as search results pages or Web pages. The received information may also include information used to generate a bidding strategy. For example, the advertiser may identify a desired page and/or slot location for a campaign. The advertiser may also provide a value specifying a percentage of impressions available to their campaign that should be displayed at the desired page and/or slot location. In some examples, the percentage of all impressions provided by the advertiser in the campaign that should be displayed at the desired page and/or slot location is a ratio of those impressions that should be shown to the total number of impressions that could possibly be presented as part of the campaign. In some examples, the advertiser may also supply an initial bid. Alternatively, the initial bid may be generated automatically, as described below.

Thus, in some implementations, the advertiser creates and names an instance of an automated bidding strategy, and chooses parameters such as the desired impression share percentage and the desired page/slot (e.g. top slot of the first page). This information is used to generate (502) a bidding strategy instance, which may be an object that is associated with any subset of “entities” in the advertiser's account with the content management system, including campaigns, groups of ads, and so forth. Associated entities will have their bids set and managed automatically by the system in the manner described herein.

An initial bid is generated (503). In some examples, bid generation engine 442 receives a notification that entities have newly come under bid management, identifies a set of keywords associated directly or indirectly with a campaign (or other entity under management), and sets an initial bid for keywords in an online content auction based on information about the keywords. In some implementations, the system examines auction events for keywords that are similar to the keyword under consideration, and identifies performance information, such as which ads won or lost their auctions and under what circumstances. For example, the system may examine performance, in other online auctions, of keywords for ads that have the same or similar creative (ad content that is displayed on the search result page) to the ad under consideration, similar associated information (e.g., keywords, geography, etc) to the ad under consideration, similar creative quality to the ad under consideration, and the like. In some examples, similarity is defined as being within a predefined range of values or characteristics. Similarity may be measured by direct comparison of two elements or based on information received from external systems.

Performance information for the same and similar keywords, in the aggregate, may be evaluated and used to set the initial bid for the bidding strategy. For example, if it is determined that the same or similar keywords, in the aggregate, generated a certain percentage of ads in a preferred location (e.g., slot, page, etc.) at ten cents per click, the initial bid for the target strategy for the keywords that are the subject of an auction may be set at ten cents per click. In other implementations, an average or weighted average of bid prices of multiple same or similar keywords may be used to set the initial bid. The average may be weighted based, e.g., on the relative number of impressions served, with bid prices for ads having a larger numbers of impressions served being weighted more heavily than bid prices for ads having fewer numbers of impressions served.

An auction is run (504) using the initial bid generated above. In some implementations, the auction may be run by code that is separate from the code used to implement process 500. The auction is against competitors of the content provider, which are also bidding for keywords that will result in display of their content in response to user input. The auction may be run by content management system 410, as explained above. Performance metrics for the initial bid are determined (505) based on its success, or failure, in the auction to achieve the impression share for a particular page/slot location set forth in the bidding strategy. In some implementations, each time an auction takes place, information about an ad whose keywords are the subject of the auction and the auction itself (including competing ads) is collected and stored in logs. These logs are used in determining performance metrics, such as impressions that were actually presented, impressions that lost in the auction, the time at which the presentation occurred, locations at which the impressions were presented on the requested page, information about user interaction with the impressions if available, quality of the ad, relevance of the ad keywords to the search terms, and so forth.

Additional information may be collected (506) from results of other auctions for the same or similar keywords. These other auctions may be actual auctions or simulations of real auctions. In this regard, in some implementations, a minimum amount of information is required to generate the function described below. Accordingly, the process can continue to run until that minimum amount of information is obtained. Alternatively, performance metrics of prior auctions for the same or similar keywords for other entities may be used. If more information is required (e.g., to generate the function described below), operations 504, 505 and 506 are repeated, as shown.

If enough information has been collected, a function is generated (508) based on the performance metrics collected, e.g., from the various auctions (including simulated auctions, if any). The function may be a mathematical function or a graphical function that relates bid price to impression share. An example of such a function is shown in FIG. 3, as described above. Thus, in some implementations, the system considers all entities managed by the bidding strategy, loads all of those entities' information (e.g., advertiser-specified information), information obtained from serving logs, and so forth, and generates a function (also called a model) for predicting future auction performance. Such a function may be used to determine a next bid, which is chosen in an attempt to further the advertiser's impression share goal. The frequency of re-bidding process can depend on advertiser-specific factors, but may occur multiple times per day, or any time any of the managed entities experiences a relevant modification. Throughout this process, the advertiser is able to check up on the actions of the automated system. For example, an advertiser can view automatic bid changes, pull down reports to check on the efficacy against a desired impression share at a location, and so forth. The bid may change, and auctions may be re-run even after the function is generated in order to update the function.

The function generated (508) based on the performance metrics may be referred to as the bid-impression share model. In some implementations, the bid-impression share model can be generated by looking at every event that occurs when a call has been made to the content management system to request advertising for a search results page that a keyword was involved in over a range of past time (e.g., days, weeks, etc.). The system may load all of these events, and simulate what would have happened if the keyword's bid were different. For example, in a specific event, if the ad did not show on the first page (e.g. because it lost to a competitor that was bidding higher), but it would have shown on the first page if its bid were higher, the system records this information. This process may be repeated over all relevant events over all possible bids over the period of time considered. At every bid, the number of shown first page impressions is recorded. The bid-impression share model is formed by dividing the number of first page impressions obtained by the maximum number that were obtainable (which includes the number of impressions that were not served because they lost an auction). This function may change over time as new serving statistics are reflected in the function's formation (e.g. if competition increases or decreases in the market for that keyword). In this way, the bid produced can reflect current market conditions.

After the function is generated, the function may be used to obtain (509) bid(s) for future online auctions. Referring to FIG. 3, for example, a user may select an impression share at the desired location and determine, from the graph, the bid price for that impression share. In some implementations, the bid price obtained from the function may be modified prior to use in an auction. For example, the current bid may be combined with (e.g., averaged with or otherwise influenced by) one or more past bids. This may be done so as to reduce the possibility of drastic bid changes over relatively short time periods (e.g., one day). In other implementations, seasonality or daily variations in bid prices may be used to modify the bid. For example, if it is known that bids required for display of content at specific times of day are less than bids required for display of content at other times, the bid price obtained from the function may be lowered by an amount that is proportional to the general decrease from one time to the other (or vice versa).

As shown, the bid may be changed (507) and new auction results may be observed. In some implementations, the bid may be changed so as to converge on the impression share for a particular page/slot location in the bidding strategy. For example, if the impression share is 60% of impressions on the first page/top slot, and the initial bid produces 30% of impressions on the first page/top slot, the bid may be increased (e.g., doubled) in an attempt to determine the bid price that achieves the desired impression share. In other implementations, the bid may be both increased and decreased incrementally (at each auction) in order to obtain information about the performance metrics that result from each bid. After each bid is changed (507), an auction is run (504), performance metrics are determined (505), a new function may be generated (508) and a new bid may be obtained (509). Thereafter, the bid may be changed (507) again to obtain more performance metrics. In some implementations, the systems described herein continuously determine performance metrics for multiple campaigns under management and the different bids therefor.

In some implementations, the system uses a feedback mechanism to increase bid robustness and/or stability. The system may use a variety of models to combine past bid(s) with a new bid that may be a function of advertiser-specific and non-advertiser-specific parameters (e.g., aggregate, structural trend, cyclical, and or seasonal effects). This is referred to as “smoothing” a bid. Example of processes for smoothing bids are provided below.

In a first example, let current_bid be the current bid in an advertising database (the bid that was active in the previous bidding period), and let model_bid be the bid determined by the process model (the function generated (508) in process 500, e.g., FIG. 5). Then, the new_bid is equal to f(current_bid, model_bid), which is a way to mix the current_bid with the model_bid to produce the new_bid, and which smoothes-out the bid transition. In this example, the smoothing function is the following:

$$\frac{1}{newbid} = \frac{α}{currentbid} + \frac{( 1 - α )}{modelbid} 0 \leq α \leq 1$$

The bigger the value of α, the more the function will take into account the value of the current_bid, and the more conservative the bid change will be relative to the bid selected from the generated function.

The foregoing smoothing function can be asymmetric with respect to bid increase and bid decrease. In particular, it can be more aggressively biased toward bid decreases. Accordingly, symmetric smoothing functions may be used in place of the foregoing smoothing function. In symmetric smoothing, if the smoothing function increases the bid by a factor of r, it should decrease the bid by a factor of 1/r if model_bid and current_bid are switched. This can be accomplished by defining two different functions for use in smoothing bids: one function where the bid is increasing and another function where the bid is decreasing, as follows:

$$\frac{1}{newbid} = \frac{α}{currentbid} + \frac{( 1 - α )}{modelbid} , if currentbid > modelbid$$

$$newbid = α currentbid + ( 1 - α ) modelbid , if currentbid < modelbid$$

These functions may be used to perform smoothing of the bid selected from the process model (model_bid) to generate a smoothed bid (new_bid). Other processes may be used in addition to, or instead of, those described herein for modifying bids.

The processes described herein for permitting advertisers to specify a particular impression share in a page/slot location may allow advertisers to understand and manage the cost/visibility tradeoff for their advertising. For example, by allowing for automated bidding, the advertiser may be able to increase the chances of presenting their ads at desired locations (e.g., page and/or slot).

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads, generated according to the processes described herein may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Elements of different implementations described herein can be combined to form other implementations not specifically set forth above. Elements can be left out of the processes, computer programs, Web pages, etc. described herein without adversely affecting their operation. In addition, the logic flows depicted in the figures do not require the particular order shown, or sequential order, to achieve desirable results. Various separate elements can be combined into one or more individual elements to perform the functions described herein.

Other implementations not specifically described herein are also within the scope of the following claims.

1. (canceled)

2. A method, comprising:
receiving, by one or more processing devices and from a content provider, a placement strategy for placement of content provided by the content provider and a bidding strategy, wherein the placement strategy specifies one or more locations at which the content is to be presented;
obtaining, by the one or more processing devices and through a feedback mechanism, results of past auctions;
adjusting, by the one or more processing devices and based on the results of the past auctions obtained through the feedback mechanism, a bid for the content provided by the content provider over multiple presentation opportunities according to the bidding strategy specified by the content provider, wherein the adjusting includes:
limiting, by the one or more processing devices and for one or more placement opportunities, the bid adjustment to be less than a target adjustment that is predicted, by the one or more processing devices, to achieve the placement strategy; and
iteratively adjusting, by the one or more processing devices, the bid amount over multiple presentation opportunities until convergence at a bid that achieves the placement strategy.

3. The method of claim 2, wherein the placement strategy further specifies a percentage of presentations of the content provided by the content provider that are to occur at the specified locations, the percentage being a ratio of a number of presentations of the content provided by the content provider at the specified locations and a total number of presentations of the content provided by the content provider.

4. The method of claim 2, wherein obtaining results of past auctions comprises:
obtaining results of past auctions for presentation of the content provided by the content provider.

5. The method of claim 2, wherein obtaining results of past auctions comprises:
obtaining results of past auctions for presentation of content items that are determined to be similar to the content provided by the content provider.

6. The method of claim 2, wherein adjusting a bid for the content provided by the content provider comprises:
determining, based on the results of the past auctions obtained through the feedback mechanism, a relationship expressing location-specific impression share as a function of bid level, wherein the relationship maps each of various bid levels to a respective percentage of presentations of the content provided by the content provider at the locations specified by the placement strategy that is achieved by the bid level; and
determining the target adjustment to the bid using the relationship expressing location-specific impression share as a function of bid level.

7. The method of claim 2, wherein adjusting the bid for the content provided by the content provider causes the bid to comply better with the placement strategy.

8. The method of claim 2, wherein the locations specified by the placement strategy are locations on a page.

9. A system comprising:
a memory storing instructions that are executable; and
a content management system including one or more computing devices that are configured to execute the instructions and perform operations comprising:
receiving, by one or more processing devices and from a content provider, a placement strategy for placement of content provided by the content provider and a bidding strategy, wherein the placement strategy specifies one or more locations at which the content is to be presented;
obtaining, by the one or more processing devices and through a feedback mechanism, results of past auctions;
adjusting, by the one or more processing devices and based on the results of the past auctions obtained through the feedback mechanism, a bid for the content provided by the content provider over multiple presentation opportunities according to the bidding strategy specified by the content provider, wherein the adjusting includes:
limiting, by the one or more processing devices and for one or more placement opportunities, the bid adjustment to be less than a target adjustment that is predicted, by the one or more processing devices, to achieve the placement strategy; and
iteratively adjusting, by the one or more processing devices, the bid amount over multiple presentation opportunities until convergence at a bid that achieves the placement strategy.

10. The system of claim 9, wherein the placement strategy further specifies a percentage of presentations of the content provided by the content provider that are to occur at the specified locations, the percentage being a ratio of a number of presentations of the content provided by the content provider at the specified locations and a total number of presentations of the content provided by the content provider.

11. The system of claim 9, wherein obtaining results of past auctions comprises:
obtaining results of past auctions for presentation of the content provided by the content provider.

12. The system of claim 9, wherein obtaining results of past auctions comprises:
obtaining results of past auctions for presentation of content items that are determined to be similar to the content provided by the content provider.

13. The system of claim 9, wherein adjusting a bid for the content provided by the content provider comprises:
determining, based on the results of the past auctions obtained through the feedback mechanism, a relationship expressing location-specific impression share as a function of bid level, wherein the relationship maps each of various bid levels to a respective percentage of presentations of the content provided by the content provider at the locations specified by the placement strategy that is achieved by the bid level; and
determining the target adjustment to the bid using the relationship expressing location-specific impression share as a function of bid level.

14. The system of claim 9, wherein adjusting the bid for the content provided by the content provider causes the bid to comply better with the placement strategy.

15. The system of claim 9, wherein the locations specified by the placement strategy are locations on a page.

16. One or more non-transitory machine-readable storage media storing instructions that when executed by one or more computing devices, cause the one or more computing devices to perform operations comprising:
receiving, by one or more processing devices and from a content provider, a placement strategy for placement of content provided by the content provider and a bidding strategy, wherein the placement strategy specifies one or more locations at which the content is to be presented;
obtaining, by the one or more processing devices and through a feedback mechanism, results of past auctions;
adjusting, by the one or more processing devices and based on the results of the past auctions obtained through the feedback mechanism, a bid for the content provided by the content provider over multiple presentation opportunities according to the bidding strategy specified by the content provider, wherein the adjusting includes:
limiting, by the one or more processing devices and for one or more placement opportunities, the bid adjustment to be less than a target adjustment that is predicted, by the one or more processing devices, to achieve the placement strategy; and
iteratively adjusting, by the one or more processing devices, the bid amount over multiple presentation opportunities until convergence at a bid that achieves the placement strategy.

17. The one or more non-transitory machine-readable storage media of claim 16, wherein the placement strategy further specifies a percentage of presentations of the content provided by the content provider that are to occur at the specified locations, the percentage being a ratio of a number of presentations of the content provided by the content provider at the specified locations and a total number of presentations of the content provided by the content provider.

18. The one or more non-transitory machine-readable storage media of claim 16, wherein obtaining results of past auctions comprises:
obtaining results of past auctions for presentation of the content provided by the content provider.

19. The one or more non-transitory machine-readable storage media of claim 16, wherein obtaining results of past auctions comprises:
obtaining results of past auctions for presentation of content items that are determined to be similar to the content provided by the content provider.

20. The one or more non-transitory machine-readable storage media of claim 16, wherein adjusting a bid for the content provided by the content provider comprises:
determining, based on the results of the past auctions obtained through the feedback mechanism, a relationship expressing location-specific impression share as a function of bid level, wherein the relationship maps each of various bid levels to a respective percentage of presentations of the content provided by the content provider at the locations specified by the placement strategy that is achieved by the bid level; and
determining the target adjustment to the bid using the relationship expressing location-specific impression share as a function of bid level.

21. The one or more non-transitory machine-readable storage media of claim 16, wherein adjusting the bid for the content provided by the content provider causes the bid to comply better with the placement strategy.
